(19) United States
(12) Patent Application Publication
(10) Pub. No.: US 2014/0222366 A1
(43) Pub. Date: Aug. 7, 2014

(54) Apparatus And Methods For Monitoring And Analysing The Performance Of A Heating Or Cooling System

(71) Applicants: Colin Calder, Berkshire (GB); Vivek Awasthi, Berkshire (GB); Fraser Harding, Berkshire (GB); Peter Roberts, Berkshire (GB); Edwin Carter, Berkshire (GB); Chloe Fotherby, Berkshire (GB)

(72) Inventors: Colin Calder, Berkshire (GB); Vivek Awasthi, Berkshire (GB); Fraser Harding, Berkshire (GB); Peter Roberts, Berkshire (GB); Edwin Carter, Berkshire (GB); Chloe Fotherby, Berkshire (GB)

(73) Assignee: PASSIVSYSTEMS LIMITED, Berkshire (GB)

(21) Appl. No.: 14/128,046

(22) PCT Filed: Jul. 3, 2012
(86) PCT No.: PCT/GB2012/051553

§ 371 Date: Apr. 9, 2014

(30) Foreign Application Priority Data
Jul. 6, 2011 (GB) 1111538.3
May 11, 2012 (GB) 1208248.3

(51) Int. Cl. G01K 1/02; G01M 99/00

(52) U.S. Cl. CPC G01K 1/024; G01M 99/005
USPC 702/130

(57) ABSTRACT

Apparatus for monitoring and analysing the performance of a heating and/or cooling system for a space within a building. The apparatus comprises a processing arrangement and an electronic memory, wherein the processing arrangement is configured to receive temperature signals representing temperature measurements from a temperature sensor within the space over a monitored period of time, to process the temperature signals so as to generate output data which attributes a proportion of the energy consumption of the heating and/or cooling system to a specified energy output, and to transmit the output data to the electronic memory for retrieval by a user. Corresponding monitoring and analysis methods are also described.

### FIELD OF THE INVENTION

The present invention relates to the monitoring and analysis of the performance of a heating and/or cooling system for a space within a building. More particularly, this is carried out with a view to reducing the energy consumption of the heating and/or cooling system.

### BACKGROUND TO THE INVENTION

Many consumers wish to reduce the energy they use to provide heating and/or cooling and/or hot water, but it can be difficult to determine the most effective and cost-efficient measures to take. Whilst generic studies and advice are available, obtaining an assessment of an individual building tends to be expensive.

The “Standard Assessment Procedure” (SAP) developed by the UK government to measure the energy consumption of domestic dwellings requires a detailed expert survey and analysis of the property.

### SUMMARY OF THE INVENTION

The present invention provides apparatus for monitoring and analysing the performance of a heating and/or cooling system for a space within a building, comprising a processing arrangement and an electronic memory, wherein the processing arrangement is configured:
to receive temperature signals representing temperature measurements from a temperature sensor within the space over a monitored period of time;
to process the temperature signals so as to generate output data which attributes a proportion of the energy consumption of the heating and/or cooling system to a specified energy output; and
to transmit the output data to the electronic memory.

The apparatus is therefore able to apportion energy consumption to a specified energy output. Output data is stored by the processing arrangement in the electronic memory for subsequent retrieval, for example in response to a request from a user. This data can be used to inform the user and/or used in further processing by the processing arrangement. A specified energy output may be one of a range of energy uses or sources of energy loss. For example, energy may be used to heat water in a central heating system, or heat water in a hot water system. Sources of energy loss may be standing losses from a hot water tank, boiler inefficiency, ventilation losses, conduction losses via walls, doors, windows, the roof, and so on.

The apparatus is arranged to capture temperature data over a period of time and this may be processed to provide information regarding the performance of the heating and/or cooling system, and the energy efficiency of the building structure.

Preferably, the processing arrangement is configured to generate output data related to an estimate of the energy consumption attributable to the specified energy output over a future period of time. This may take into account a specified change to a control setting of the system or a physical change to the structure of the building or the system.

It may enable the effect of a change to a control setting of a system or a physical change to the structure of the building or the system to be predicted. The prediction may be made with reference to pre-stored data in the electronic memory which is related to known characteristics and/or parameters of the system and/or building.

In this way, a consumer is able to gain a better understanding of the relative merits of changes to the heating or cooling system and/or building, without necessarily requiring significant additional input from the user or incurring substantial equipment costs.

In contrast to a survey providing a “snapshot” of the system and building characteristics, the present invention facilitates ongoing monitoring and analysis, capturing data over an extended period of time and therefore providing more information regarding the performance of the heating or cooling system.

The present invention further provides apparatus for monitoring the performance of a heating and/or cooling generation arrangement in a heating and/or cooling system, comprising a processing arrangement and an electronic memory, wherein the processing arrangement is configured:
to receive outflow temperature signals representing temperature measurements from an outflow sensor arranged to detect the temperature of an outflow pipe from the heating and/or cooling generation arrangement over a period of time; and
to receive fuel consumption data related to the fuel consumption of the arrangement over the time period to calibrate an algorithm for estimating the fuel consumption of the heating and/or cooling generation arrangement with reference to the outflow pipe temperature.

Once the apparatus has been calibrated, for example with respect to two or more readings from an incoming fuel meter, the fuel consumption over subsequent periods may be estimated with respect to the outflow temperature signals without requiring the entry of further meter readings.

According to a further aspect, the invention provides a method of monitoring and analysing the performance of a heating and/or cooling system for a space within a building, wherein the method comprises the steps of:
receiving in a processing arrangement temperature signals representing temperature measurements from a temperature sensor within the space over a monitored period of time;
processing the temperature signals with the processing arrangement so as to generate output data which attributes a proportion of the energy consumption of the heating and/or cooling system to a specified energy output; and
transmitting the output data to an electronic memory for retrieval by a user.

The invention also provides a method of monitoring the performance of a heating and/or cooling generation arrangement, wherein the method comprises the steps of:
receiving in a processing arrangement outflow temperature signals representing temperature measurements from an outflow sensor arranged to detect the temperature of an outflow pipe from the heating and/or cooling generation arrangement of the system over a period of time; and
receiving fuel consumption data related to the fuel consumption of the system over the time period to calibrate an algorithm for estimating the fuel consumption of the heating and/or cooling generation arrangement with reference to the outflow pipe temperature.

### BRIEF DESCRIPTION OF THE DRAWINGS

Embodiments of the invention will now be described by way of example and with reference to the accompanying schematic drawings, wherein:

FIG. 1 is a block diagram showing apparatus for monitoring and analysing the performance of a heating system according to an embodiment of the invention;

FIG. 2 is a flow diagram representing a method for monitoring and analysing the performance of a heating system according to an embodiment of the invention;

FIG. 3 is a graph showing a plot of water tank temperature against height;

FIG. 4 is a block diagram showing a heating system including hot water and space heating together with added temperature sensors;

FIG. 5 is a graph showing an example of a histogram of temperature gradients for a heated space; and

FIGS. 6 and 7 show examples of information displayed to a user by apparatus embodying the present invention.

### DETAILED DESCRIPTION OF THE DRAWINGS

Apparatus embodying the invention can be used to produce quantitative and financial conclusions that help a consumer reduce their energy consumption and therefore the associated costs, and assist the consumer in assessing the performance of their heating or cooling system. Information may be collated in a home energy report for presentation to the user.

In overview, a heating and/or cooling system may be monitored on an ongoing basis. The monitoring system may be closely associated with and possibly have several components in common with the control arrangement for the heating/cooling system. Characteristics and parameters of the heating/cooling system in the associated building may be deduced from measured temperatures at different points around the system and building. Measured values and/or information derived from them may be provided to the user in real time or stored for subsequent display and/or analysis. The apparatus may be configured to compare the characteristics and performance of the building with similar structures.

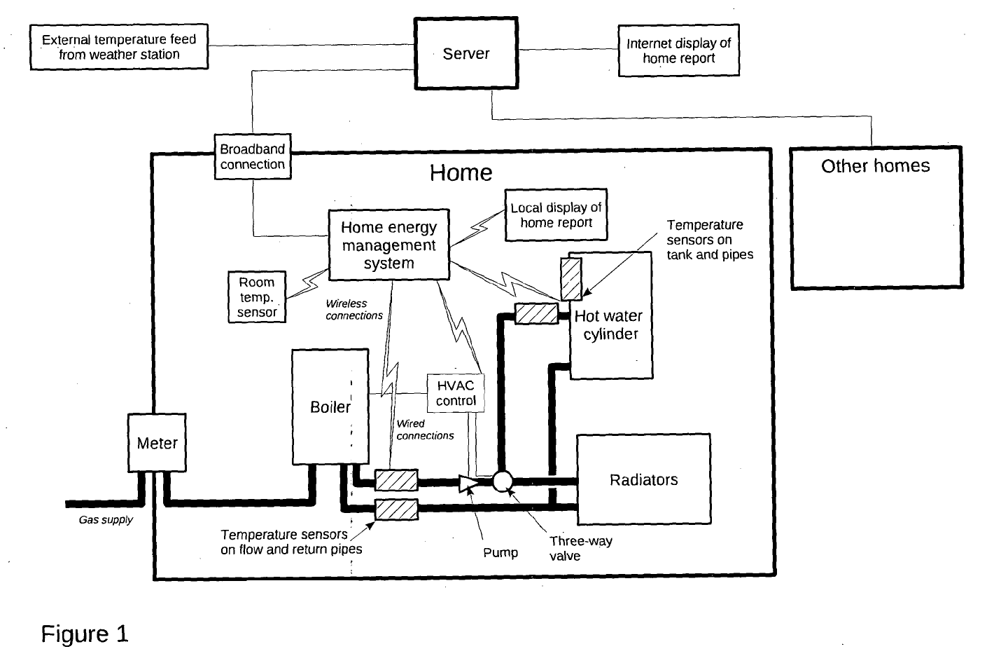

FIG. 1 shows a diagram representing an apparatus embodying the present invention in association with a home heated by a gas boiler and radiators and having an Internet connection. Information is made available to the user via a dedicated display within the home, and/or via a user's general purpose electronic device such as a laptop, PDA or smartphone. Connections between devices may be wired, wireless and via a home network or via an Internet.

Information regarding external weather conditions may be obtained from sensors located at the building. Alternatively, it may be supplied from a weather information service. As well as temperature information, the supplied data may also relate to other weather parameters such as wind speed, direction and/or rainfall.

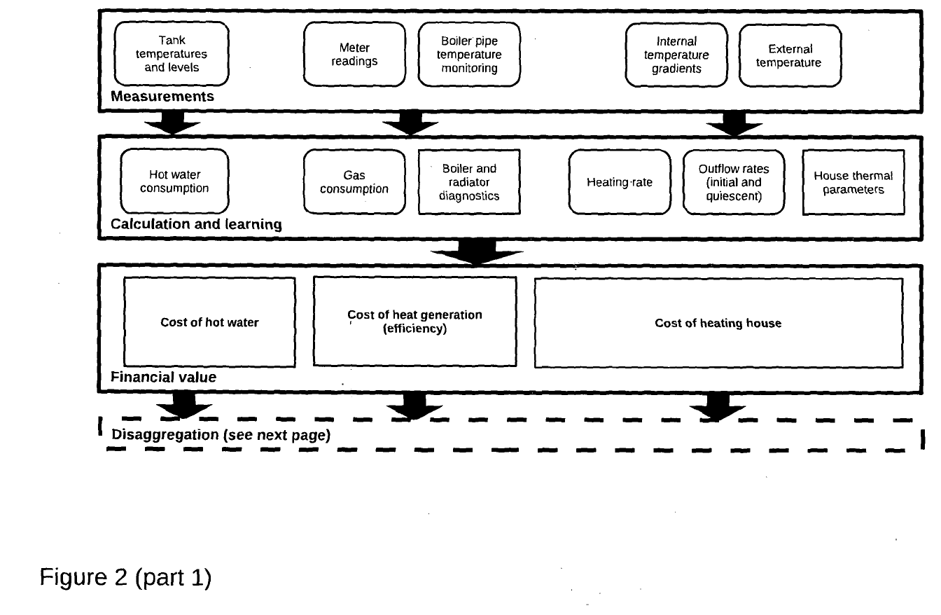

A process by which data may be gathered and analysed according to an embodiment of the invention is depicted in FIG. 2. A number of measurements are taken, such as pipe and air temperatures, together with meter readings providing fuel usage. Processing and combining these measurements enables derived quantities to be calculated for presentation to a user.

Output data may be divided into a generation report and a consumption report, both of which may be converted to financial values. The generation report provides information regarding the efficiency and configuration of the building's heating/cooling system. The overall consumption may be disaggregated in the consumption report according to how much money (or energy, carbon and so on) is being spent on what.

Hot water heating costs may be determined, and further divided into tank losses and hot water usage (using information from tank temperature sensors). The costs associated with space heating may be separated into ventilative and conductive losses (for example using information regarding the structure and construction of the building, temperature measurements and/or weather information). The conductive losses may be subdivided into losses via walls, windows, and the roof for example (using structural data and possibly additional sensors).

Information gathered may be compared with known baselines and/or houses of a similar category or construction.

Results of the analysis may be collated into a report. This may recommend interventions or changes the user could make, either in terms of the control of the system, or physical changes to the structure of the building or system, such as installing insulation or replacing a boiler. The resulting change in energy consumption may be calculated and presented to the user (in terms of energy, financial or carbon emission savings for example).

Aspects of this approach will now be described in more detail below. The term “heat plant” is used to identify a building's source of heat energy or heat generation arrangement. This is often a boiler, but it could equally be another source such as a heat pump. The fuel consumed may be gas, oil, biomass or another fuel. Whilst the following description is generally in terms of a heating system, it may similarly be applied to a cooling system, and/or combined heating and cooling system for similar monitoring and analysis purposes.

### House and Heat Plant Characterisation

The apparatus may be configured to calculate how quickly a building loses energy and how quickly its heating system is able to provide heat, as well as providing diagnostic information about the heating system.

The apparatus may constantly (or frequently) monitor the air temperature at one or more places in the building. By observing the rate at which the interior of the building cools when no heat is being provided by the heat plant, the apparatus can calculate the “outflow rate” from the interior in degrees C. per hour. This is proportional to the rate at which energy is lost through the walls, roof, windows and so on, and thus provides an indication of how well the building is insulated.

The outflow rate is affected by the external temperature and the heating history of the building. It is therefore preferable to compensate for these factors and determine an average value of the outflow rate over time.

The outflow rate may be artificially high when the building fabric is at a lower temperature and acts as a heat sink. This typically occurs shortly after the internal temperature has hit a peak (and perhaps earlier in a heating period). This may be termed “the initial outflow rate”. The outflow rate may be artificially low when the building fabric is at a warmer temperature and acts as a heat source. This typically occurs several hours after heating was last applied and may be termed “the quiescent outflow rate”. The initial and quiescent outflow rates may be averaged to estimate the true value of the outflow rate which lies between these two values.

Assuming the temperature delta between inside and outside remains the same (or has been compensated for), the difference between the initial outflow and quiescent outflow rates is an indication of the thermal mass of the building. A greater difference indicates a greater thermal mass.

External temperature measurement is important to the calculation of an outflow rate according to embodiments of the invention. This may be measured directly, or obtained from a weather information service for example. The rate of energy loss is the overall thermal conductance of the building's external structure multiplied by the temperature difference between inside and outside.

The actual rate of energy loss from a building is approximately its thermal mass (heat capacity) multiplied by the outflow rate. If the total thermal energy put into the building by its heat plant is known, the rate of energy loss (as a power for example) may be estimated using the outflow rate.

The apparatus may also monitor the rate at which the building warms up when its heat plant is providing heat, that is “the heating rate” of the building. However, at the same time, the building is also losing heat at the outflow rate. The heat output of a heat plant is therefore the outflow rate plus the heating rate. This may be termed the “zero-delta heating rate” of a building (as when there is no temperature difference, there is no outflow), for example in degrees C. per hour. This may be seen as equivalent to the power rating of a heat plant divided by the thermal heat capacity of the building.

The zero-delta heating rate provides an indication to the user of how effective their heat plant is at heating their building. It can suggest how the power rating of their heat plant plus the parameters of the heat output system (for example radiators, underfloor heating) compares to the needs of the building. This may assist a user in determining whether insufficient heating in cold weather is due to poor insulation (indicated by a high outflow rate) or an undersized heat plant or heat output system (indicated by a low zero-delta heating rate).

The processing arrangement may be configured to calculate a heating or cooling rate value for the space and the associated heating or cooling system by calculating a temperature gradient value related to the value of the temperature in the space at intervals over at least one period of time, storing each calculated temperature gradient value, and using the stored temperature gradient values to determine the heating or cooling rate value.

Similarly, the processing arrangement may be configured to calculate an energy outflow rate value for the space by calculating a temperature gradient value related to the rate of change of the temperature in the space at intervals over at least one period of time, storing each calculated temperature gradient value, and using the stored temperature gradient values to determine the energy outflow rate value.

Determination of heating and outflow rates may be improved using statistical methods over an extended period (such as a month). For example, the outflow rate can be estimated by averaging temperature gradients, excluding those above zero or in a percentage of outliers, and/or excluding those during sunlight hours, and/or excluding known heating activation times. For example, the heating rate can be estimated as the 90ₜₕ percentile of temperature gradients above a threshold (so that a representative maximum is recorded—heating rates flatten off as the system equilibrates), including only heating activation times if known.

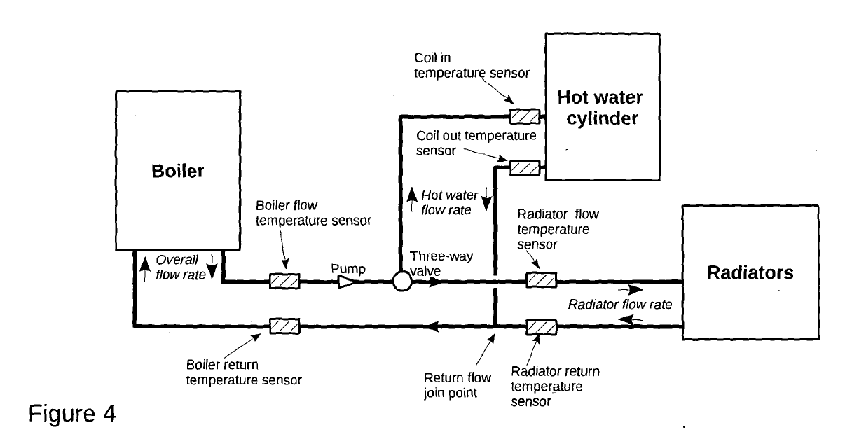

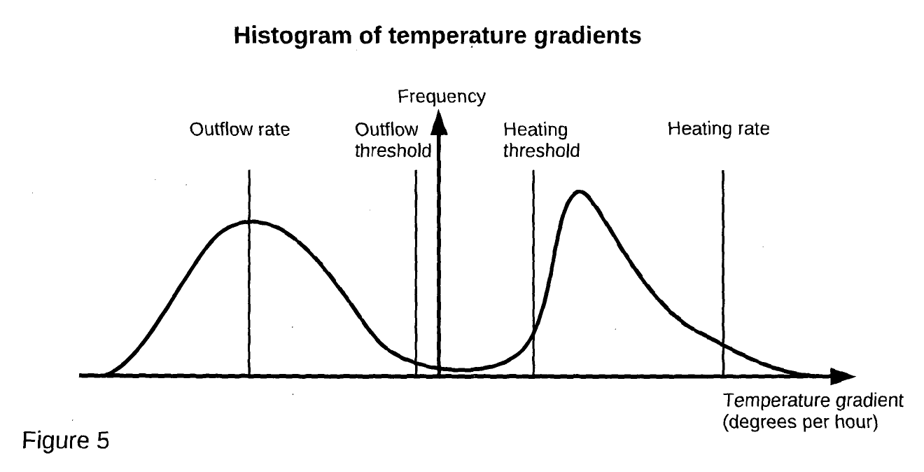

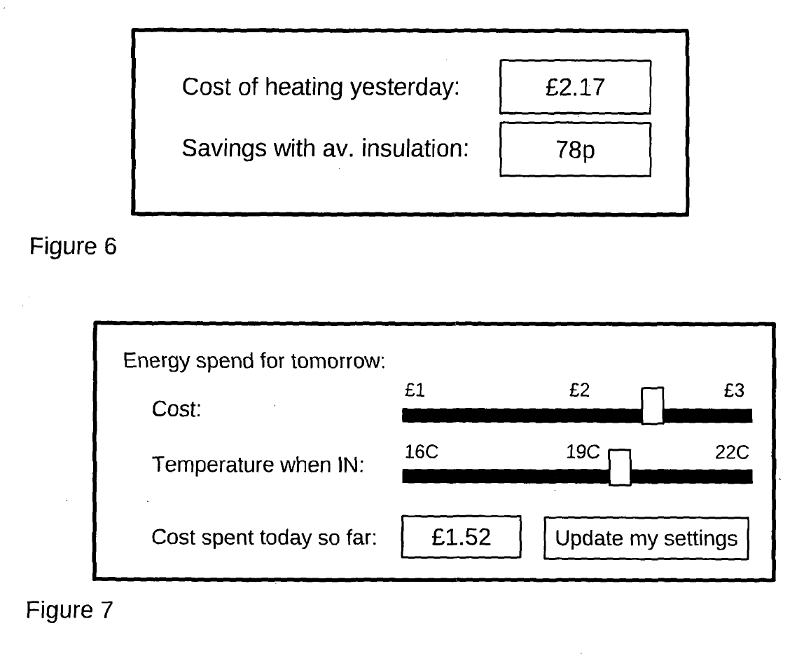

A meaningful outflow rate can be determined as a percentile (preferably 50^{th} percentile, median) or mean outflow rate below an outflow threshold rate (see FIG. 5).

Preferably, times only contribute to the outflow rate histogram if they are overnight and part of an extended period of cooling at least a certain time after heating has been observed. Preferably, outliers are excluded if using the mean (e.g. the lowermost (e.g bottom 15%) and the uppermost (e.g. top 15%) of rates below the threshold removed). Preferably, outflow rates are weather compensated by dividing by the temperature difference to the outside (and then are termed outflow coefficients rather than rates).

A meaningful heating rate can be determined as a percentile (preferably high, e.g. 90^{th}) heating rate above a heating threshold rate. Preferably, measurements only contribute to the heating rate histogram if they are part of an extended period of heating. Preferably, heating rates are weather compensated by subtracting the current estimated outflow rate, determined by multiplying the outflow coefficient (previously determined) by the current temperature difference to outside.

The inventors have determined that a more accurate measure of boiler fuel consumption (whether gas, oil or biomass for example) may be determined by monitoring the actual firing time of a boiler, as boilers tend to cycle on and off during periods within which heating is requested. Preferably this is achieved by monitoring the temperature of the boiler outflow pipe.

The outflow pipe temperature may be monitored over a given period to calibrate an algorithm for estimating the fuel consumption of the boiler with reference to the outflow pipe temperature. The corresponding absolute fuel consumption over the given period is determined by taking a fuel meter reading at the beginning and end of the period. An algorithm is thereby calibrated which provides an estimate of the boiler fuel consumption during a time period by reference to the outflow pipe temperature profile over that period.

Where a boiler modulates the input fuel flow, a second temperature sensor may be provided to monitor the inflow pipe to estimate the relative boiler burn rate. By taking a meter reading at the beginning and end of a measurement period, the absolute fuel consumption during the periods when the burner is on may be estimated.

In the case of a combination boiler, a further temperature sensor is associated with the hot water outflow pipe to monitor the generation of hot water by the boiler for calibration purposes and then during subsequent monitoring.

Thus, three temperature sensors are preferably employed to calibrate and monitor the fuel consumption of a modulating combination boiler: one on each of the heating outflow, the hot water outflow and the inflow pipes.

A non-modulating combination boiler may only need two temperature sensors to be deployed to facilitate calibration and monitoring, namely one on the heating outflow pipe, and one on the hot water outflow pipe.

The fuel burn rate may be compared to a stated nominal burn rate for the heat plant in its specification. If there is a significant deviation, this suggests there may be issues that require further investigation. For example, it may be recommended to a user that the boiler is serviced. There may be partial blockage of fuel pathways in the boiler for example.

Measuring the flow and return temperatures from a heat plant can indicate its relative performance (assuming constant water flow and fuel consumption). This temperature difference may also indicate whether radiators in the heat output system are correctly balanced.

Unexpectedly high temperatures in pipes may suggest a faulty valve in the system. For example, if heating but not hot water is requested, then the pipe into the hot water cylinder from the heat plant should not get warm.

An initial measurement of the water flow rate through the system enables the temperature difference between the heat plant inflow and outflow pipes to be used to calculate the thermal energy delivered by the heat plant (assuming constant pump speed). This enables the efficiency of the heat plant to be determined with reference to its fuel consumption. This leads to the identification of inefficient or failing boilers, as well as a reduced flow rate suggesting a pipe blockage for example. The water flow rate for this calculation should be measured for a fixed pipe resistance, otherwise the flow rate can vary (for example due to valve position, thermostatic radiators valves, and so on). Preferably, measurements are taken during periods when the heat plant is heating hot water only, when there will be a fixed pipe resistance. A portable non-invasive flow meter (for example an ultrasonic device) may be used to measure the water flow rate. This may be measured initially during installation of the apparatus for example.

The processing arrangement may be configured to receive temperature signals from sensors associated with pipes of the system and determine a parameter indicative of the relative flow rates in a space heating portion and a hot water portion of the system.

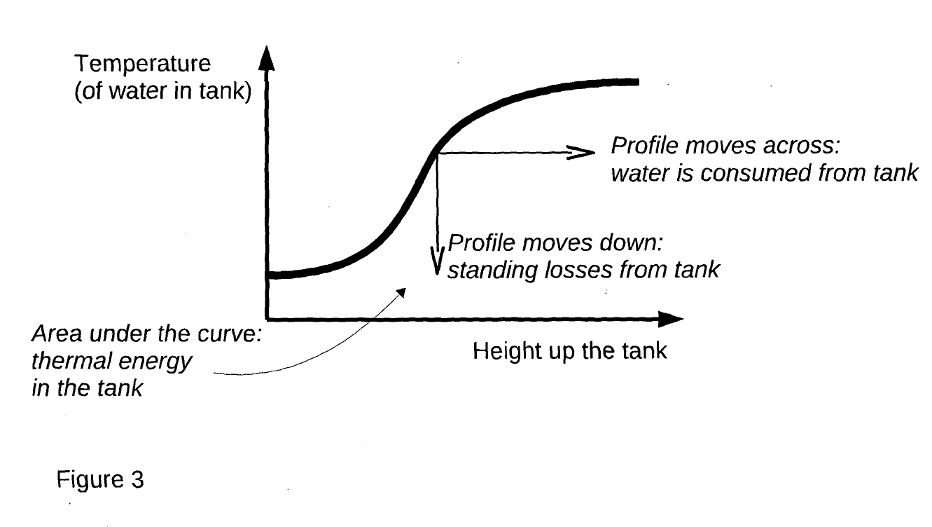

Relative water flow rates in the space heating and hot water systems can be estimated as follows. As shown in FIG. 4, temperature sensors are installed in the return pipes from the space heating and hot water systems, just before and after they join back together (the third may be the same as the sensor on the inflow pipe to the boiler). The ratios of these temperatures indicates the ratio of the water flow rates through the heating and hot water systems, assuming that thermal energy is conserved. This ratio can be used to identify faults such as sludge in the hot water cylinder.

Looking at thermal power balance at the return flow join point marked in FIG. 4:

Radiator flow rate×Radiator return temperature+Hot water flow rate×Coil out temperature=Overall flow rate×Boiler return temperature

Given that:

Overall flow rate=Radiator flow rate+Hot water flow rate

It can be determined that:

Radiator flow rate÷Hot water flow rate=(Boiler return temperature−Coil out temperature)÷(Radiator return temperature−Boiler return temperature)

The temperatures should be averaged during periods when both hot water and space heating are requested (which periods can be deduced from all flow temperatures being similar and high).

The apparatus may be configured to attribute heat losses to ventilation losses and conduction losses through the fabric of the building for example. This may be valuable in determining interventions to recommend to a user. For example, increasing roof insulation may be less worthwhile if most heat is lost through draughts. The proportion of heat losses attributable to ventilation or conduction losses may be estimated with reference to weather information. For example, ventilation losses are likely to be greater when it is windy, whereas conduction losses are likely to be greater when walls are wet.

Conductive losses can be further sub-divided for the benefit of the user according to whether heat is lost through walls, windows, doors, the roof or the ground for example. This may be calculated with reference to structural data (such as information regarding the size and type of windows and doors and information about the construction of the building and the like), weather information and/or additional sensors. One such additional sensor may be a temporary sensor deployed to measure the thermal conductance of a barrier structure of the building (such as a wall or loft insulation or a door). This may be implemented in the form of two temperature sensors, separated by a material of known thermal conductance. One of the sensors is placed close to the building structure, with the other exposed to the ambient air (preferably protected against fluctuations from draughts and so on). The ratio of these two temperatures at equilibrium together with the temperature on the other side of the structure enables the thermal conductance of the structure to be estimated. The material of known thermal conductance should preferably be sufficiently large to minimise edge effects. In practice a diameter of around 60 cm may be sufficient. Although this measurement is preferably performed under circumstances of equilibrium when the heat flow is constant, averaging techniques over time may nevertheless be employed to get accurate values notwithstanding fluctuation of internal and external temperatures.

In some embodiments, the apparatus may be arranged to receive information indicative of the occupancy of the building. This may indicate whether occupants are in, out or likely to be asleep. As well as being used to control the heating system, this information may assist with characterising the thermal properties of the building and disaggregating heat losses. For example when a building is occupied, more heat is introduced to its interior (for example from body heat, electrical devices, open fires and so on), but when people are out, doors and windows will not be moved, indicating that ventilation arrangements will be unchanged.

### Hot Water Characterisation

The apparatus may be configured to provide information about a building's stored hot water system. Measurement of the temperature profile of a hot water cylinder using temperature sensors enables the usage of water to be determined (see the present applicant's earlier UK patent application no. 1019758.0), along with a measure of its relative energy content (or its absolute energy content if the volume of the tank is known). Monitoring the temperature profile over time enables characterisation of the cylinder in terms for example of how fast it loses energy, and how much of the energy used to heat the tank is actually consumed (in baths, showers and so on) as opposed to being lost from the tank into the surrounding air.

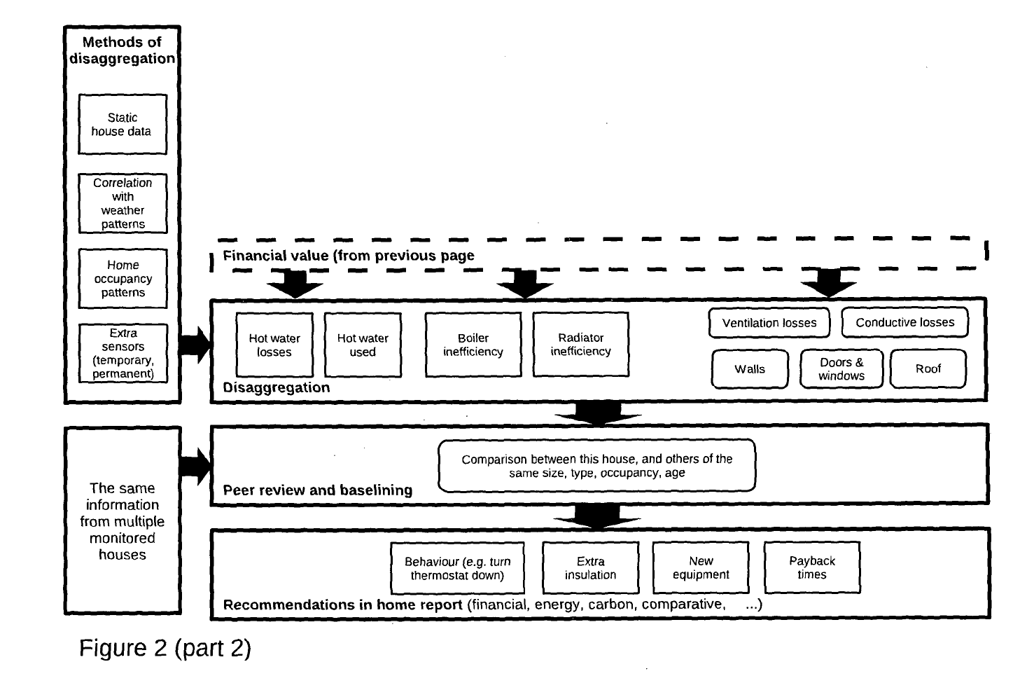

The apparatus may be configured to distinguish between standing losses and hot water usage. It may be coupled to several temperature sensors which enable the temperature profile of the water in the tank to be measured. Standing losses appear as a uniform reduction in temperature (albeit slightly greater in the hotter part of the tank), whereas usage appears as the temperature profile shifting up the tank as cold water enters at the bottom (see FIG. 3).

Arranging the apparatus to determine the amount of hot water thermal energy lost versus consumed enables the user to determine the sufficiency of their cylinder insulation as well as the efficiency of their hot water usage, that is how much of the heated water is actually being used. This may be presented to the user in terms of a financial valuation and/or comparison with baselines and/or other similar installations.

The apparatus may be configured to apply similar methods to systems that provide instantaneous hot water such as a combi-boiler. Pipe temperatures may be measured to estimate the amount of hot water consumed and how much heat is lost from hot water in pipework.

The apparatus may be configured to calculate a measure of the energy losses from a pipe of the system by monitoring the temperature at two different locations along the pipe.

Pipework losses may be estimated with four temperature sensors installed on the flow and return pipes towards each end of a stretch of pipework. During a period when the water flow is entirely contained to this loop, pipework losses can be estimated as the ratio of the temperature differences at each end. This applies for example to a system boiler for the pipework to the hot water tank.

With reference to FIG. 4, it will be appreciated that:

Power delivered by the boiler=C×Overall flow rate×(Boiler flow temperature−Boiler return temperature)

Power received by the hot water tank=C×Hot water flow rate×(Coil in temperature−Coil out temperature)

where C is the volumetric heat capacity of the fluid in the heating system.

Usually, there are significant lengths of pipework between the boiler and the rest of the system (unlike the representation of FIG. 4), and so there will be heat lost from the pipework:

Power delivered by the boiler=Power received by the hot water tank+Pipework losses

Fraction of power lost in pipework=Pipework losses÷Power delivered by the boiler=1−Power received by the hot water tank÷Power delivered by the boiler

During periods when hot water only is requested, the hot water flow rate is the same as the overall flow rate, and hence we can say that:

Fraction of power lost in pipework=1−(Coil in temperature−Coil out temperature)÷(Boiler flow temperature−Boiler return temperature)

where the temperatures are averaged over times when hot water only is requested. These times can be deduced from coil in and boiler flow temperatures being similar and high, and the radiator flow temperature being low.

### Financial Analysis

Apparatus embodying the invention may advantageously be configured to calculate the financial equivalent of values determined with regard to the system monitoring. These calculations will be specific to the building concerned and enable changes resulting from interventions such as improved insulation to be monitored. The user may also be informed how the costs break down (for example between heating and hot water) and the effects of proposed changes can be represented as a monetary value, illustrating the justification for upgrades to more energy-efficient equipment or indicating a predicted payback time. The efficacy of interventions can be validated after installation, to the benefit of the user (and any other parties with a financial interest such as investors).

A method for calculating the financial equivalent of energy usage will now be described with reference to a boiler, although it will be appreciated that this technique applies equally to other heat plants. Boiler activation may be determined by monitoring the temperature of an outflow pipe (as described in the present applicant's earlier UK patent application no. 1021205.8). This provides a measure of how long the boiler is actually burning fuel, rather than making calculations based on the time period for which heating is requested (as the boiler may not actually be firing due to its internal thermostat). In the case of a modulating boiler, the gas flow may be inferred from the temperature difference between the outflow and inflow pipes of the boiler to the heating system.

The cost of future fuel usage may then be estimated by capturing temperature data over a period of time and recording two or more readings over that period of time together with tariff information.

The apparatus may then be configured to calculate:
the total money spent on heating and hot water over a specified time period;
the money spent on space heating versus hot water heating;
the money spent on overnight heating versus daytime heating;
how much of the cost of hot water is attributable to tank losses as opposed to water actually used;
the cost of maintaining the building at a given temperature for a specified period (at a given outside temperature);
how much money would be saved if the heating system thermostat was turned down by one degree for example;
how much money is saved when the heating or hot water regime is changed (for example changing from timed firing to automatically managed energy);
how much money is saved by making a physical change to the building (for example installing insulation);
the cost savings associated with replacing an inefficient boiler.

The apparatus may be adapted to monitor an oil-fired boiler. Instead of using meter readings to calibrate a fuel consumption algorithm, tank level measurements may be employed and combined with information about the tank geometry to estimate fuel consumption. This allows oil consumption to be subsequently estimated without requiring permanent installation of a meter or sensor on the tank, instead by reference to the boiler outflow temperature. The apparatus may therefore be arranged to estimate the amount of oil consumed since the last refill (and thus how much is left in the tank) and the user can be alerted when a refill is required (or the apparatus could be arranged to automatically alert a supplier when a refill is required).

The apparatus may be configured to indicate a measure of the uncertainty in any measurements and/or predictions. This may be calculated for example with reference to prior testing of the measurement techniques on trial buildings.

### Networked Monitoring

Information gathered by apparatus embodying the invention may be processed on site and the results made available to the user. Alternatively or in addition, gathered information may be sent to a remote server for processing. Results may be returned to the home apparatus and/or made available to a use, for example via the Internet.

Data gathered from the building may be compared with data relating to other buildings of a similar type, either locally or on a remote server. Similar type may refer to size, layout (for example medium-sized, three bedroom, detached) and/or year of build and/or occupancy (for example a family, retirees, professionals out at work all day). These factors may have a significant impact on the energy consumption independently of how a heating system is used and the associated energy consumption. Comparison of data and results with similar buildings may assist a user in assessing the implications of the results. For example, the comparisons may indicate how well insulated the building is compared to others, how quickly the building heats up compared to others, how much the building costs to heat overall compared to others (also broken down with respect to heating and hot water), and how lossy the hot water tank is compared to others.

The results of monitoring analysis may be compared by the apparatus with other measures, for example surveys such as an SAP. This may indicate whether the predictions of the survey are reflected in practice by the monitoring.

FIG. 4 is an example of a display indicating a prediction of a potential saving achievable by improving insulation to an average standard.

FIG. 5 shows a user interface which enables control of a heating system having regard to the cost of the associated energy consumption, with reference to the desired internal temperature during periods of occupancy. The cost of the energy consumed so far during the current day is also indicated.

By monitoring and analysing the past performance of the heating and/or cooling system in the building using apparatus embodying the present invention, it is then possible to use this data to predict the cost of maintaining the interior at a given temperature. This may take into account weather forecast data and/or the expected building occupancy during the relevant period. The user can then make an informed selection of the desired temperature setpoint or profile over a future period. The setpoint can be chosen so as to reach an acceptable balance between comfort and the associated cost for the fuel consumption. This can cause changes in the behaviour of the consumer that could be more beneficial than a structural intervention in the building such as adding more insulation.

Embodiments of the present apparatus can also assist the user's understanding of the effects of control adjustments and structural interventions, giving a more realistic appreciation of the system performance and the fuel cost implications. For instance, if double glazing has been installed, the consumer may overestimate its benefits and have a misguided impression that heat loss is now much lower than before. The consumer may assume that increasing the setpoint will then have minimal impact on cost due to the improved insulation. In fact, double glazing might only provide a marginal improvement to the insulating properties of the building as a whole. It has been observed in practice that installing double glazing can in fact lead to an increase in a consumer's energy bill, because the consumer then overestimates the benefits and increases their setpoint for improved comfort. By providing with information derived using the present apparatus, the consumer is able to make better informed choices about future control settings and structural changes to the building or the heating/cooling system.

By way of example, a sample output report which may be generated by apparatus embodying the invention is set out below.

### Sample House Report

### House Statistics

Typical temperature loss per hour on a cold day: 0.84° C./hour.

Calculated assuming an 18 C difference between internal and external temperature, and based on actual home data gathered over last few days.

Recommendation: This value is 36% below the average house of your type, and as such your house could benefit from extra insulation.

Heating rate of your house: 1.31° C./hour.

This is how quickly your house would heat when the boiler is on assuming an 18 C difference between internal and external temperature.

Recommendation: This value is 16% higher that the average heating rate of a house of your type, and as such indicates your boiler/radiator combination is well balanced for the size of your house.

Max hot water cylinder standing losses: 30% per day

Assumes a full tank of water, and this indicates how much energy is lost through the tank walls over 24 hours.

Recent hot water cylinder standing losses: 24% in the last 24 hours

This is the percentage amount of energy your tank lost in the last 24 hours.

Energy use over last 24 hours:

Gas consumed: 7.82 m³ based over 4.5 hours of boiler time.

Cost based on your current tariff: £2.34 (inc VAT)

Of which is broken down into;
Hot water: 17 p
of which is broken down into;
Tank losses: 4 p
Actual water used: 13 p
Heating: £2.17
Comment: This indicates your heating use is xx % above average, but your hot water use is xx % below average.
Gas required to heat your home by 1 C: 0.43 m³ (=13 p)
Gas required to maintain 18 C on a cold day: £2.62
Cold day is defined as 0 C external temperature.
Saving if thermostat reduced by 1 C: 14.5 p
Assumes house is kept at 18 C for 24 hrs

### Advisory Notes

Estimated boiler condensing performance: xx %

Recommendation: This value is below typical. Reducing your boiler temperature (if your boiler supports this—it is typically a knob on your boiler) would improve this, and as the heating rate of your house is above average, it should not cause noticeable discomfort.

Heating: If the home insulation was improved to bring it up to “average” heat loss, then you would have saved 78 p over the last 24 hours.

Recommendation: Consider insulation.

Average heat loss has been calculated from statistics of real homes that have PassivSystems controls installed, and over the last few days stands at 0.60 C/hour calculated for a cold day.

Hot water: Standing losses for your tank are xx % less than typical, indicating your tank hot water is well managed and your insulation is good.

Recommendation: No action required.

Gas burn rate: According to your boiler manual, your gas burn rate is within tolerances for your boiler.

Recommendation: No action required.

Gas required to heat your house is xx % more than average for a typical house.

Recommendation: This may indicate your boiler is not efficient, but could also be as a result of your house not being comparable to the typical house (e.g. could be larger).

Valves and boiler firing: Operating as expected.

1-68. (canceled)

69. Apparatus for monitoring and analysing the performance of a heating and/or cooling system for a space within a building, comprising a processing arrangement and an electronic memory, wherein the processing arrangement is configured:
to receive temperature signals representing temperature measurements from a temperature sensor within the space over a monitored period of time;
to process the temperature signals so as to generate output data which attributes a proportion of the energy consumption of the heating and/or cooling system to a specified energy output; and
to transmit the output data to the electronic memory for retrieval by a user.

70. Apparatus of claim 69, including an outflow sensor arranged to detect the temperature of an outflow pipe from a heating or cooling generation arrangement of the system, and generate an outflow temperature signal responsive thereto for transmission to the processing arrangement.

71. Apparatus of claim 70, wherein the processing arrangement is configured to receive fuel consumption data corresponding to the fuel consumption against time over the monitored time period, and to use the fuel consumption data to calibrate an algorithm for estimating the fuel consumption of the heating or cooling generation arrangement with reference to the outflow pipe temperature.

72. Apparatus of claim 69, wherein the processing arrangement includes a system activation input for receiving a system activation signal indicative of when a heating and/or cooling generation arrangement of the system is activated.

73. Apparatus of claim 69, wherein the heating and/or cooling generation arrangement is a combination boiler and an outflow sensor is arranged to detect the temperature of a hot water outflow pipe from the boiler and generate a hot water outflow temperature signal responsive thereto for transmission to the processing arrangement for calibration and/or monitoring purposes.

74. Apparatus of claim 69, wherein the heating and/or cooling generation arrangement is an oil-fired boiler and an outflow sensor is arranged to detect the temperature of a hot water outflow pipe from the boiler, and the processing arrangement is configured to receive two or more readings representing the level of the oil in an oil tank supplying the oil-fired boiler over a time period to calibrate an algorithm for estimating the fuel consumption of the boiler with reference to the temperature of the hot water outflow pipe from the boiler.

75. Apparatus of claim 74, wherein the processing arrangement is configured to determine when the level of the oil in an oil tank supplying the oil-fired boiler reaches a predetermined threshold, and generate an alert signal in response thereto.

76. Apparatus of claim 70, including an inflow temperature sensor arranged to detect the temperature of an inflow pipe to the heating and/or cooling generation arrangement of the system, and generate an inflow temperature signal responsive thereto for transmission to the processing arrangement for calibration and/or monitoring purposes.

77. Apparatus of claim 76, wherein the processing arrangement is configured to estimate the fuel consumption of the heating and/or cooling generation arrangement with reference to the inflow and outflow temperature signals over the monitored time period.

78. Apparatus of claim 77, wherein the processing arrangement is configured to calculate a measure of the performance of the heating and/or cooling generation arrangement with reference to the inflow and outflow temperature signals over the monitored time period.

79. Apparatus of claim 77, wherein the processing arrangement is configured to calculate a measure of the efficiency of the heating and/or cooling generation arrangement with reference to the inflow and outflow temperature signals over the monitored time period, the fuel consumed over the time period, and a value retrieved from the memory representing a rate of fluid outflow.

80. Apparatus of claim 79, wherein the inflow and outflow temperature signals and rate of fluid outflow relate to a hot water supply system.

81. Apparatus of claim 69, including an outflow pipe temperature sensor for generating an output signal responsive to the temperature of or in an hot water outflow pipe of a hot water tank, wherein the outflow pipe temperature sensor is used to detect when water is being drawn from the tank.

82. Apparatus of claim 69, wherein the processing arrangement is configured to detect a potential fault in the system with respect to temperature signals from sensors associated with the system.

83. Apparatus of claim 82, wherein the processing arrangement is configured to receive temperature signals from sensors associated with pipes of the system and determine a parameter indicative of the relative flow rates in a space heating portion and a hot water portion of the system.

84. Apparatus for monitoring the performance of a heating and/or cooling generation arrangement in a heating and/or cooling system, comprising a processing arrangement and an electronic memory, wherein the processing arrangement is configured:
to receive outflow temperature signals representing temperature measurements from an outflow sensor arranged to detect the temperature of an outflow pipe from the heating and/or cooling generation arrangement over a period of time; and
to receive fuel consumption data related to the fuel consumption of the arrangement over the time period to calibrate an algorithm for estimating the fuel consumption of the heating and/or cooling generation arrangement with reference to the outflow pipe temperature.

85. Apparatus of claim 84, wherein the processing arrangement includes a system activation input for receiving a system activation signal indicative of when a heating and/or cooling generation arrangement of the system is activated.

86. Apparatus of claim 84, wherein the heating and/or cooling generation arrangement is a combination boiler and an outflow sensor is arranged to detect the temperature of a hot water outflow pipe from the boiler and generate a hot water outflow temperature signal responsive thereto for transmission to the processing arrangement for calibration and/or monitoring purposes.

87. Apparatus of claim 84, wherein the heating and/or cooling generation arrangement is an oil-fired boiler and an outflow sensor is arranged to detect the temperature of a hot water outflow pipe from the boiler, and the processing arrangement is configured to receive two or more readings representing the level of the oil in an oil tank supplying the oil-fired boiler over a time period to calibrate an algorithm for estimating the fuel consumption of the boiler with reference to the temperature of the hot water outflow pipe from the boiler.

88. Apparatus of claim 87, wherein the processing arrangement is configured to determine when the level of the oil in an oil tank supplying the oil-fired boiler reaches a predetermined threshold, and generate an alert signal in response thereto.

89. Apparatus of claim 84, including an inflow temperature sensor arranged to detect the temperature of an inflow pipe to the generation arrangement of the system, and generate an inflow temperature signal responsive thereto for transmission to the processing arrangement, and/or an outflow sensor arranged to detect the temperature of an outflow pipe from the generation arrangement of the system, and generate an outflow temperature signal responsive thereto for transmission to the processing arrangement.

90. Apparatus of claim 89, wherein the processing arrangement is configured to estimate the fuel consumption of the heating and/or cooling generation arrangement with reference to the inflow and outflow temperature signals over the monitored time period.

91. Apparatus of claim 89, wherein the processing arrangement is configured to calculate a measure of the performance of the heating and/or cooling generation arrangement with reference to the inflow and outflow temperature signals over the monitored time period.

92. Apparatus of claim 89, wherein the processing arrangement is configured to calculate a measure of the efficiency of the heating and/or cooling generation arrangement with reference to the inflow and outflow temperature signals over the monitored time period, the fuel consumed over the time period, and a value retrieved from the memory representing a rate of fluid outflow.

93. Apparatus of claim 92, wherein the inflow and outflow temperature signals and rate of fluid outflow relate to a hot water supply system.

94. Apparatus of claim 84, including an outflow pipe temperature sensor for generating an output signal responsive to the temperature of or in an hot water outflow pipe of a hot water tank, wherein the outflow pipe temperature sensor is used to detect when water is being drawn from the tank.

95. Apparatus of claim 84, wherein the processing arrangement is configured to detect a potential fault in the system with respect to temperature signals from sensors associated with the system.

96. Apparatus of claim 95, wherein the processing arrangement is configured to receive temperature signals from sensors associated with pipes of the system and determine a parameter indicative of the relative flow rates in a space heating portion and a hot water portion of the system.

97. A method of monitoring and analysing the performance of a heating and/or cooling system for a space within a building, wherein the method comprises the steps of:
receiving in a processing arrangement temperature signals representing temperature measurements from a temperature sensor within the space over a monitored period of time;
processing the temperature signals with the processing arrangement so as to generate output data which attributes a proportion of the energy consumption of the heating and/or cooling system to a specified energy output; and
transmitting the output data to an electronic memory for retrieval by a user.

98. A method of monitoring and analysing the performance of a heating and/or cooling system for a space within a building using an apparatus of claim 69.

99. A computer program comprising program instructions for causing a computer to perform the method of claim 97.

100. A method of monitoring the performance of a heating and/or cooling generation arrangement, wherein the method comprises the steps of:
receiving in a processing arrangement outflow temperature signals representing temperature measurements from an outflow sensor arranged to detect the temperature of an outflow pipe from the heating and/or cooling generation arrangement of the system over a period of time; and
receiving fuel consumption data related to the fuel consumption of the system over the time period to calibrate an algorithm for estimating the fuel consumption of the heating and/or cooling generation arrangement with reference to the outflow pipe temperature.

101. A method of monitoring and analysing the performance of a heating and/or cooling system for a space within a building using an apparatus of claim 84.

102. A computer program comprising program instructions for causing a computer to perform the method of claim 100.
